(19) United States
(12) Patent Application Publication
(10) Pub. No.: US 2026/0313339 A1
(43) Pub. Date: Oct. 8, 2026

(54) LOCATION BASED SERVICE (LBS) ENHANCED BY SHORT-RANGE WIRELESS COMMUNICATION

(71) Applicant: Telefonaktiebolaget LM Ericsson (publ), Stockholm (SE)

(72) Inventor: Yanping DANG, Beijing (CN)

(21) Appl. No.: 18/996,672

(22) PCT Filed: Jul. 19, 2022
(86) PCT No.: PCT/CN2022/106430

§ 371 Date: Jan. 17, 2025

(51) Int. Cl. H04W 4/80; H04W 4/02; H04W 64/00

(52) U.S. Cl. CPC H04W 4/80; H04W 4/023; H04W 4/027; H04W 64/006

(57) ABSTRACT

The present disclosure is related to a terminal device, a server, and methods for location based service enhanced by short-range wireless communication. A method at a server for locating a first terminal device, the method includes: selecting, from one or more terminal devices, at least one second terminal device based on at least first information reported by the first terminal device and/or second information reported by the at least one second terminal device, the first information indicating a second identifier of the at least one second terminal device received by the first terminal device via short-range wireless communication, the second information indicating a first identifier of the first terminal device received by the at least one second terminal device via short-range wireless communication; and determining a location of the first terminal device based on at least a location of the at least one second terminal device.

### CROSS REFERENCE TO RELATED APPLICATIONS

This application is a 35 U.S.C. § 371 national stage application of PCT International Application No. PCT/CN2022/106430 filed on Jul. 19, 2022, the disclosure and content of which is incorporated by reference herein in its entirety.

### TECHNICAL FIELD

The present disclosure is related to the field of wireless communication, and in particular, to a terminal device, a server, and a method for enhancing a location based service (LBS) with short-range wireless communication.

### BACKGROUND

A location-based service (LBS) is a general term denoting software services which use geographic data and information to provide services or information to users. LBS can be used in a variety of contexts, such as health, indoor object search, entertainment, work, personal life, etc. Commonly used examples of location based services include navigation software, social networking services, location-based advertising, and tracking systems. LBS can also include mobile commerce when taking the form of coupons or advertising directed at customers based on their current location. LBS also includes personalized weather services and even location-based games.

Several categories of methods can be used to find the location of a mobile device. A simple and standard solution is LBS based on Global Positioning System (GPS) or an alternative satellite navigation system. It is used to maintain knowledge of the exact location, however can be expensive for the end-user, as they would have to invest in a GPS-equipped handset. GPS is based on the concept of trilateration, a basic geometric principle that allows finding one location if one knows its distance from other, already known locations.

However, due to the signal attenuation caused by construction materials, the satellite based positioning solutions, such as GPS, GALILEO, GLONASS, BeiDou, lose significant power indoors affecting the required coverage for receivers by at least four satellites. In addition, the multiple reflections at surfaces cause multi-path propagation serving for uncontrollable errors. These very same effects are degrading all known solutions for indoor locating which uses electromagnetic waves from indoor transmitters to indoor receivers.

### SUMMARY

According to a first aspect of the present disclosure, a method at a server for locating a first terminal device is provided. The method comprises: selecting, from one or more terminal devices, at least one second terminal device based on at least first information reported by the first terminal device and/or second information reported by the at least one second terminal device, the first information indicating a second identifier of the at least one second terminal device received by the first terminal device via short-range wireless communication, the second information indicating a first identifier of the first terminal device received by the at least one second terminal device via short-range wireless communication; and determining a location of the first terminal device based on at least a location of the at least one second terminal device.

In some embodiments, before the step of selecting the at least one second terminal device, the method further comprises at least one of: receiving, from the first terminal device, the first information; receiving, from the at least one second terminal device, the second information; and receiving, from a device other than the first terminal device and/or the at least one second terminal devices, the first information and/or the second information. In some embodiments, the step of selecting the at least one second terminal device further comprises: selecting the at least one second terminal device further based on at least a specified period of time. In some embodiments, the first information further indicates that the second identifier of the at least one second terminal device is received by the first terminal device during the specified period of time. In some embodiments, the second information further indicates that the first identifier of the first terminal device is received by the at least one second terminal device during the specified period of time.

In some embodiments, the step of selecting the at least one second terminal device comprises: selecting multiple second terminal devices based on at least the first information and/or the second information. In some embodiments, the method further comprises: sorting locations of the multiple second terminal devices by their corresponding timestamps, each location being associated with a timestamp indicating when the corresponding second terminal device receives the first identifier of the first terminal device and/or the first terminal device receives the second identifier of the corresponding second terminal device; and determining a trajectory of the first terminal device based on at least the sorted locations of the multiple second terminal devices. In some embodiments, the step of determining the location of the first terminal device comprises: predicting the location of the first terminal device based on at least the determined trajectory of the first terminal device.

In some embodiments, the one or more terminal devices comprise at least one of: a terminal device that is associated with a fixed location; a terminal device that is able to locate itself by its own positioning module; and a terminal device that is able to locate itself by communicating with another terminal device. In some embodiments, an identifier of a terminal device is a permanent identifier of the terminal device or a temporary identifier that is assigned by a server periodically or in response to a trigger event. In some embodiments, an identifier of a terminal device is generated based on a pseudo random sequence and a personal identity of a user associated with the terminal device. In some embodiments, the short-range wireless communication comprises at least one of: Wi-Fi communication; Near Field Communication (NFC) communication; Radio Frequency Identification (RFID) communication; Bluetooth communication; Bluetooth Low Energy (BLE) communication; ZigBee communication; Z-Wave communication; Infrared Data Association (IrDA) communication; and 3rd Generation Partnership Project (3GPP) Sidelink (SL) communication.

According to a second aspect of the present disclosure, a server is provided. The server comprises: a processor; a memory storing instructions which, when executed by the processor, cause the processor to perform any of the methods of the first aspect. According to a third aspect of the present disclosure, a server for locating a first terminal device is provided. The server comprises: a selecting module configured to select, from one or more terminal devices, at least one second terminal device based on at least first information reported by the first terminal device and/or second information reported by the at least one second terminal device, the first information indicating a second identifier of the at least one second terminal device received by the first terminal device via short-range wireless communication, the second information indicating a first identifier of the first terminal device received by the at least one second terminal device via short-range wireless communication; and a determining module configured to determine a location of the first terminal device based on at least a location of the at least one second terminal device. In some embodiments, the server may comprise one or more further modules, each of which may perform any of the steps of any of the methods of the first aspect.

According to a fourth aspect of the present disclosure, a method at a first terminal device for facilitating a server in locating the first terminal device is provided. The method comprises: detecting whether there is a short-range wireless signal from a second terminal device; receiving, from the second terminal device, a second identifier of the second terminal device in response to detecting that there is a short-range wireless signal from the second terminal device; and reporting, to the server, information indicating the second identifier of the second terminal device.

In some embodiments, the method further comprises: transmitting, to the second terminal device, a first identifier of the first terminal device in response to detecting that there is a short-range wireless signal from the second terminal device. In some embodiments, before the step of receiving the second identifier of the second terminal device and/or the step of transmitting the first identifier of the first terminal device, the method further comprises: determining whether the detected short-range wireless signal from the second terminal device has a higher signal strength than a threshold or not, wherein the step of receiving the second identifier of the second terminal device and/or the step of transmitting the first identifier of the first terminal device are performed further in response to determining that the detected short-range wireless signal from the second terminal device has a higher signal strength than the threshold.

In some embodiments, after the step of transmitting, to the second terminal device, a first identifier of the first terminal device, the method further comprises: starting a timer for preventing retransmission of the first identifier of the first terminal device to the second terminal device; and preventing the first identifier of the first terminal device from being transmitted to the one second terminal device again until the timer expires. In some embodiments, before the step of receiving the second identifier of the second terminal device and/or the step of transmitting the first identifier of the first terminal device, the method further comprises: establishing a short-range connection with the second terminal device.

In some embodiments, when multiple short-range wireless signals from multiple second terminal devices are detected, the step of receiving the second identifier of the second terminal device and/or the step of transmitting the first identifier of the first terminal device are performed for the multiple second terminal devices one by one. In some embodiments, the step of receiving the second identifier of the multiple second terminal devices and/or the step of transmitting the first identifier of the first terminal device are performed for the multiple second terminal devices one by one in a decreasing order of their signal strengths.

In some embodiments, the information reported to the server further comprises at least one of: a timestamp indicating when the second identifier of the second terminal device is received by the first terminal device; and a location where the second identifier of the second terminal device is received by the first terminal device. In some embodiments, an identifier of a terminal device is a permanent identifier of the terminal device or a temporary identifier that is assigned by a server periodically or in response to a trigger event. In some embodiments, an identifier of a terminal device is generated based on a pseudo random sequence and a personal identity of a user associated with the terminal device. In some embodiments, the short-range wireless signal comprises at least one of: a Wi-Fi signal; an NFC signal; an RFID signal; a Bluetooth signal; a BLE signal; a ZigBee signal; a Z-Wave signal; an IrDA signal; and a 3GPP SL signal.

According to a fifth aspect of the present disclosure, a terminal device is provided. The terminal device comprises: a processor; a memory storing instructions which, when executed by the processor, cause the processor to perform any of the methods of the fourth aspect.

According to a sixth aspect of the present disclosure, a first terminal device for facilitating a server in locating the first terminal device is provided. The first terminal device comprises: a detecting module configured to whether there is a short-range wireless signal from a second terminal device; a receiving module configured to receive, from the second terminal device, a second identifier of the second terminal device in response to detecting that there is a short-range wireless signal from the second terminal device; and a reporting module configured to report, to the server, information indicating the second identifier of the second terminal device. In some embodiments, the terminal device may comprise one or more further modules, each of which may perform any of the steps of any of the methods of the fourth aspect.

According to a seventh aspect of the present disclosure, a computer program comprising instructions is provided. The instructions, when executed by at least one processor, cause the at least one processor to carry out any of the methods of the first aspect and/or the fourth aspect.

According to an eighth aspect of the present disclosure, a carrier containing the computer program of the seventh aspect is provided. The carrier is one of an electronic signal, optical signal, radio signal, or computer readable storage medium.

According to a sixth aspect of the present disclosure, a system for locating a terminal device is provided. The system comprises: one or more terminal devices of the fifth or sixth aspect; and a server of the second or third aspect.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary system for locating a terminal device based on short-range wireless communication according to an embodiment of the present disclosure.

FIG. 2A and FIG. 2B are diagrams illustrating exemplary scenarios without and with the terminal device locating based on short-range wireless communication according to an embodiment of the present disclosure applied, respectively.

FIG. 3 is a diagram illustrating an exemplary table of items reported from the terminal devices shown in FIG. 2B according to an embodiment of the present disclosure.

FIG. 4 is a diagram illustrating an exemplary procedure for locating a terminal device based on short-range wireless communication according to an embodiment of the present disclosure.

FIG. 5 is a diagram illustrating another exemplary scenario where an LBS is enhanced by short-range wireless communication according to an embodiment of the present disclosure.

FIG. 6 is a diagram illustrating an exemplary table of items reported from the terminal devices shown in FIG. 5 according to another embodiment of the present disclosure.

FIG. 7A and FIG. 7B are diagrams illustrating an exemplary procedure for enhancing an LBS with short-range wireless communication according to an embodiment of the present disclosure.

FIG. 8 is a flow chart illustrating an exemplary method at a server for locating a terminal device according to an embodiment of the present disclosure.

FIG. 9 is a flow chart illustrating an exemplary method at a terminal device for facilitating a server in locating the terminal device according to an embodiment of the present disclosure.

FIG. 10 schematically shows an embodiment of an arrangement which may be used in a server or a terminal device according to an embodiment of the present disclosure.

FIG. 11 is a block diagram of an exemplary server according to an embodiment of the present disclosure.

FIG. 12 is a block diagram of an exemplary terminal device according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G New Radio (NR), the present disclosure is not limited thereto. In fact, as long as LBS enhanced by short-range wireless communication is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), 4th Generation Long Term Evolution (LTE), LTE-Advance (LTE-A), or 5th Generation New Radio (5G NR), etc. Therefore, one skilled in the arts could readily understand that the terms used herein may also refer to their equivalents in any other infrastructure. For example, the term “User Equipment” or “UE” used herein may refer to a terminal device, a mobile device, a mobile terminal, a mobile station, a user device, a user terminal, a wireless device, a wireless terminal, or any other equivalents. For another example, the term “gNB” used herein may refer to a network node, a base station, a base transceiver station, an access point, a hot spot, a NodeB, an Evolved NodeB, a network element, or any other equivalents.

As mentioned above, a satellite-based positioning module, such as a GPS module, can be expensive for end-users, as they would have to invest in a GPS-equipped mobile device. Further, there are many types of mobile devices that do not have a satellite-based positioning module. However, the LBS are still needed by the owners of these mobile devices. In such a case, a solution for locating a terminal device without a satellite-based positioning module is needed.

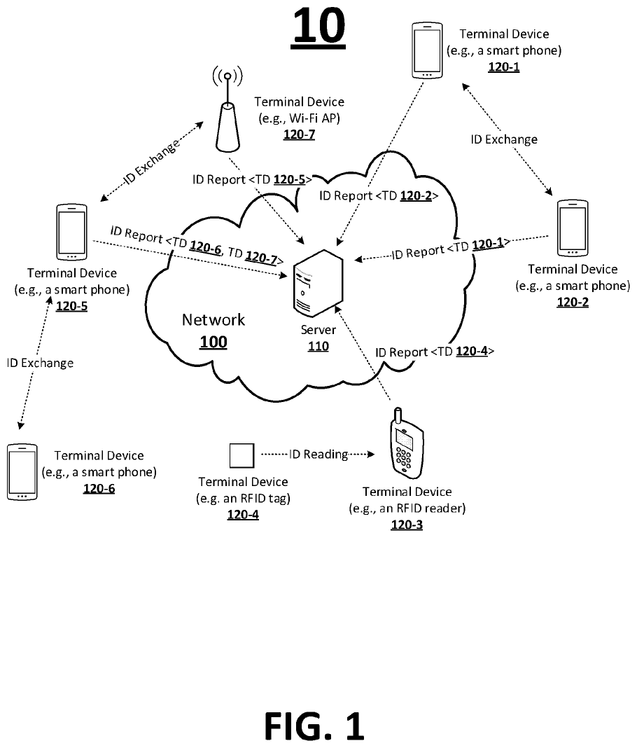

FIG. 1 is a diagram illustrating an exemplary system 10 for locating a terminal device based on short-range wireless communication according to an embodiment of the present disclosure. As shown in FIG. 1, the system 10 may comprise but not limited to a server 110 and multiple terminal devices 120-1 through 120-7 (collectively, the terminal devices 120). However, the present disclosure is not limited thereto. In some other embodiments, the system 10 may comprise any appropriate number of terminal devices and any appropriate number of servers.

In some embodiments, the server 110 may be located in a network 100, such as the Internet, an intranet, a Local Area Network (LAN), or any network that can be accessed by the terminal devices 120. As shown in FIG. 1, the terminal devices 120 may communicate with each other via short-range wireless communication and exchange their IDs with each other. For example, the terminal device 120-1 (e.g., a smart phone) may exchange its ID with the terminal device 120-2 (e.g., another smart phone), for example, via Bluetooth communication. For another example, the terminal device 120-3 (e.g., an RFID reader) may read or otherwise obtain the ID of the terminal device 120-4 (e.g., an RFID tag), for example, via RFID communication. For yet another example, the terminal device 120-5 (e.g., a smart phone) may exchange its ID with the terminal device 120-6 (e.g., another smart phone) and the terminal device (e.g., a Wi-Fi Access Point (AP)), for example, via Wi-Fi communication. However, the present disclosure is not limited thereto. In some other embodiments, one or more short-range wireless communication technologies can be applied, comprising but not limited to: Wi-Fi, NFC, RFID, Bluetooth, BLE, ZigBee, Z-Wave, IrDA, or 3GPP SL.

In some embodiments, one or more terminal devices 120 may provide their own locations to other nearby terminal devices via short-range wireless communication, such that the other nearby terminal devices, which do not know their own locations, may be aware of the locations to which they are close. In other words, a location of a terminal device may be determined indirectly.

For example, the terminal device 120-1 may have no GPS module installed and cannot determine its own location by itself while the terminal device 120-2 may have a GPS module installed and can determine its own location by itself. In such a case, when the terminal device 120-1 receives the ID of the terminal device 120-2 via short-range wireless communication, the terminal device 120-1 may receive the location of the terminal device 120-2 also. For another example, the terminal device or Wi-Fi AP 120-7 may be installed at a fixed location, and therefore it may be aware of its own geographical location. When exchanging the IDs with the terminal device 120-5, the terminal device 120-7 may provide its own geographical location directly to the terminal device 120-5. Alternatively or additionally, when the ID of the terminal device 120-7 is received by the terminal device 120-5, the terminal device 120-5 may be aware of the geographical location of the terminal device 120-7 by querying a database (or a third party device) that stores the association between the geographical location and the ID of the terminal device 120-7. Therefore, the terminal devices 120 may be aware of their own locations based on the received or otherwise determined locations of the nearby terminal devices 120. In such a case, an LBS can be provided on the terminal devices 120 even if they cannot determine their own locations by themselves.

As shown in FIG. 1, the terminal devices 120 may report the IDs received from other terminal devices to the server 110. For example, the terminal device 120-1 may report the ID of the terminal device 120-2 to the server 110, while the terminal device 120-2 may report the ID of the terminal device 120-1 to the server 110. For another example, the terminal device 120-3 may report the ID of the terminal device 120-4 to the server 110. However, the terminal device 120-4 does not report the ID of the terminal device 120-3 to the server 110, for example, because the terminal device 120-4 is merely an RFID tag that can only passively respond to a signal pulse without any communication capability. Similarly, the terminal devices 120-5 and 120-7 may report their collected IDs to the server 110, while the terminal device 120-6 cannot report its collected IDs since it may be out of range or have no access to the server 110 even if it receives the ID of the terminal device 120-5. In such a case, the terminal device 120-6 may report its collected IDs at a later time instance, for example, when its access to the server 110 is restored or otherwise enabled.

In general, the embodiment shown in FIG. 1 provides an automatic and accurate collection of the contact information through devices which equipped with short-range wireless communication technology. The terminal devices 120 may comprise but not limited to smart phones (e.g., 120-1, 120-2, 120-5, 120-6), smart wearable devices (e.g., a smart watch, smart glasses), dedicated wearable devices (e.g., 120-4), dedicated fixed-location devices (e.g., 120-7). These devices may be worn by a person or installed at a fixed location, and each device may have a unique ID which may be linked to a person ID or a geographical location. When a terminal device detects other surrounding devices that are closer to itself than a predefined distance, the terminal device may automatically set up a short-range wireless connection and exchange IDs with each other. In some embodiments, a timestamp corresponding to this exchange may be recorded too. In some embodiments, the collected IDs may be reported immediately. In some embodiments, the collected IDs may be uploaded regularly to the server 110. With the reported IDs, the server 110 may, for example, easily determine the track of a certain terminal device, for example, the terminal device associated with a missing child. For another example where a restraining order is involved, with the reported IDs, an alert may be generated by the server 100 as an evidence if a restricted person (e.g., a paroled suspect) breaks the restrictions of contacts or locations, for example, by a terminal device associated with the restricted person approaching a protected person or a protected location (or his/her/its associated terminal device).

Therefore, this solution may provide the more valuable record for quick and accurate analysis of missing child, and it also can force a restricted person to follow the legal restriction and not to get into the restricted places or get close to the specific protected persons. In addition, it can also trigger warning on devices of both specific protected person and restricted person if they are in short distance.

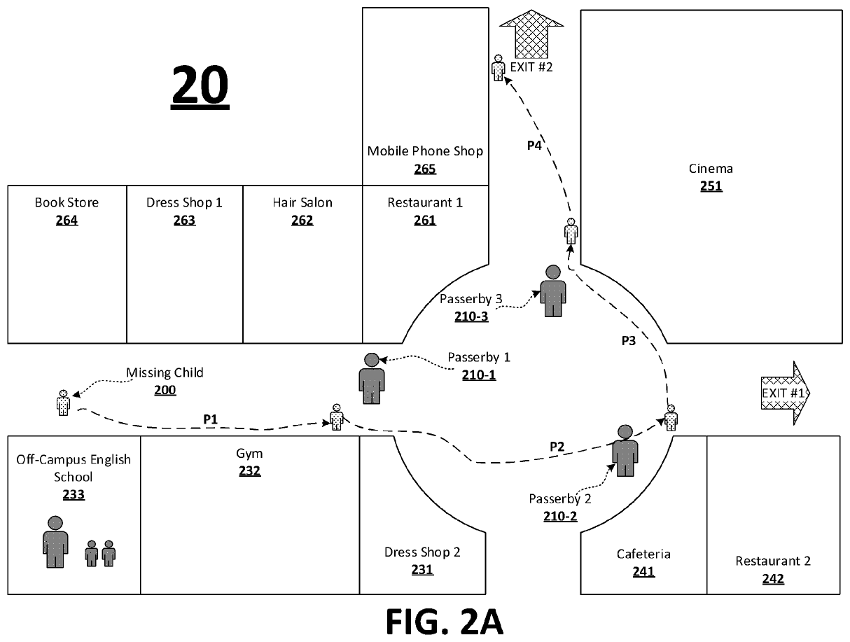

Next, two exemplary scenarios, “missing child” and “restraining order” in which the solution shown in FIG. 1 will be described in detail with reference to FIG. 2A through FIG. 7B, respectively. However, the present disclosure is not limited thereto. In some other embodiments, the solution may be applicable to other appropriate scenarios.

FIG. 2A and FIG. 2B are diagrams illustrating exemplary scenarios 20 without and with the terminal device locating based on short-range wireless communication according to an embodiment of the present disclosure applied, respectively.

An exemplary floor plan of a shopping mall is shown in FIG. 2A and FIG. 2B in which multiple brick and mortar stores are comprised. For example, there are a restaurant #1 261, a hair salon 262, a dress shop #1 263, a book store 264, a mobile phone shop 255, another dress shop #2 231, a gym 232, an off-campus English school 233, a cinema 251, a cafeteria 241, and another restaurant #2 242. However, the present disclosure is not limited thereto. In some other embodiments, the scenario 20 may comprise more stores, less stores, or different stores, and may have a different layout of the floor plan. Further, as shown in FIG. 2A and FIG. 2B, one or more customers 210-1, 210-2, 210-3 (collectively, the customers 210) and one or more children may be shopping or wandering around in one or more of the stores.

Referring to FIG. 2A where the solution shown in FIG. 1 is not applied, a missing (or lost) child 200 may leave the English school 233 accidently and wandering around the mall, as indicated by the path P1->P2->P3->P4 and leave the mall at the exit #2. When the parents are looking for the child 200, they are not aware of this path and have to ask the passersby they meet whether they saw their child. For example, when the parents meet the passerby #2 210-2, the passerby #2 210-2 may tell them that a child was walking towards the exit #1 when the passerby #2 210-2 met the missing child 200. In such a case, the parents may be misled and search for the child down to the road starting from the exit #1.

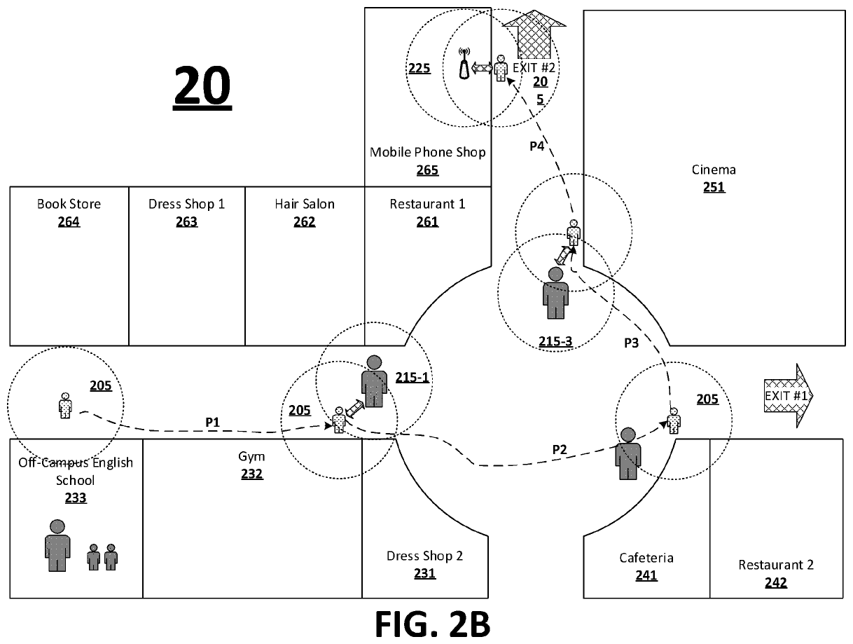

Referring to FIG. 2B where the solution shown in FIG. 1 is applied, a terminal device 205 (e.g., a smart watch or a terminal device embedded into the shoes) associated with the child 200 may exchange the IDs with any other terminal devices that are close thereto. For example, the terminal device 205 may exchange its ID with the terminal device 215-1 associated to the passerby #1 210-1, the terminal devices 215-3 associated to the passerby #1 210-3, and the terminal device 225 (e.g., a Wi-Fi or Bluetooth AP or hotspot) associated to the mobile phone shop 265. In such a case, the server 110 may receive multiple reports from the terminal devices 205, 215-1, 215-3, and 225, and record the reports in a table, for example, the table shown in FIG. 3. As shown in FIG. 3, each report may comprise at least an ID of a terminal device that communicated with the reporting terminal device via short-range wireless communication once. For example, the reporting terminal device 205 may report the ID of the terminal device 215-1 since it was close to the terminal device 215-1 when the missing child 200 was wandering as shown in FIG. 2A and FIG. 2B.

In some embodiments, a report may further comprise an optional timestamp associated with the ID exchange, such that the server 110 may sort the reports by their timestamps and determine a trajectory of the missing child 200 as shown in FIG. 2B. In some other embodiments, the timestamp may be determined by the server 110 itself. For example, when a terminal device report an ID of another terminal device immediately once the ID is received, the server 110 may consider the time at which the report is received as the timestamp associated with the ID exchange.

In some embodiments, a report may further comprise an optional location associated with the ID exchange, for example, when the reporting terminal device has another way to position itself, for example, by GPS, GALILEO, GLONASS, BeiDou, or the like. In some embodiments where a terminal device is associated with a fixed location (e.g., the mobile phone shop 265 shown in FIG. 2B), the geographical location of the fixed location may be registered at the server 110 in advance, such that the reporting terminal device may be associated with this geographical location at the server 110 when it reports the ID of the terminal device associated with the fixed location.

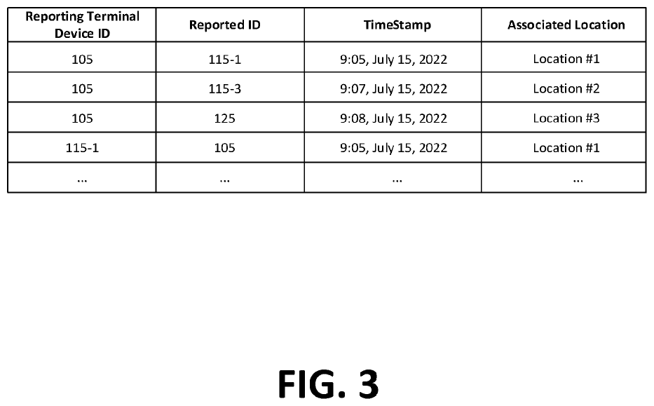

An exemplary procedure for locating the missing child 200/its associated terminal device 205 based on short-range wireless communication will be described with reference to FIG. 4 together with FIG. 2B and FIG. 3. The procedure may begin with step S405 where the terminal device 205 may detect a signal from the terminal device 215-1 and establish a connection with the terminal device 215-1 to exchange IDs therebetween. At step S410a and S410b, the terminal devices 205 and 215-1 may report their received IDs to the server 110. However, the present disclosure is not limited thereto. In some embodiments, the terminal device 205 and/or the terminal device 215-1 may store the received IDs locally without immediate reporting, and later report all IDs received during a certain period of time altogether to the server 110. Similarly, the terminal device 205 may exchange the IDs of the terminal device 215-3 and the hotspot 225 at steps S415 and S425, respectively, and report the exchanged IDs at steps S420a, S420b, S430a, and S430b, respectively. In some embodiments, the reporting of the IDs is not mandatory for a single device. For example, when a terminal device has no access to the server 110 (e.g., the RFID tag 120-4 and the smart phone 120-6 shown in FIG. 1), the other terminal device (e.g., the RFID reader 120-3) may report the close contact between the two terminal devices to the server 110.

Further, in some embodiments, the IDs of the terminal device 205 and/or the terminal device 215-1 may be reported to the server 110 via another device than the terminal device 205 and/or the terminal device 215-1. For example, an ID report may be relayed to the server 110 via a different device than a reporting terminal device.

At a later point, the parents may query the server 110 for the missing child 200 at step S435, and it may predict, estimate, or otherwise determine the location of the missing child 200 and/or its associated terminal device 205 based on at least the historical location records, for example, those shown in FIG. 3. In some embodiments, the location of the terminal device 205 may be determined based on the trajectory that is determined based on the historical location records. However, the present disclosure is not limited thereto.

In some embodiments where only a single terminal device (e.g., the terminal device 215-3) exchanges its ID with the terminal device 205, the location of the terminal device 205 may be determined as an area (e.g., a circular area) centered at the location of the single terminal device 215-3 with a radius that is increasing as time goes by. For example, with reference to only the second entry in the table shown in FIG. 3, the location of the terminal device 205 may be determined as a circular area centered at “Location #2” with an initial radius of 10 meters that is increasing as time goes by.

In some embodiments where two terminal devices exchange their IDs with the terminal device 205 simultaneously or almost simultaneously, the location of the terminal device 205 may be determined as an intersection area of the two areas (e.g., circular areas) centered at the locations of the two terminal devices, respectively, with radiuses that are increasing as time goes by. For example, when the terminal device 205 exchange the IDs with the terminal devices 215-1 and 215-3 simultaneously or almost simultaneously, the location of the terminal device 205 may be determined as an intersection area of the two circular areas centered at “Location #1” and “Location #2” with initial radiuses of 10 meters that are increasing as time goes by.

In some embodiments where three or more terminal devices exchange their IDs with the terminal device 205 simultaneously or almost simultaneously, the location of the terminal device 205 may be determined in a similar manner, for example, determined as an intersection area of the three or more areas (e.g., circular areas) centered at the locations of the three or more terminal devices, respectively, with radiuses that are increasing as time goes by. In some other embodiments where three or more terminal devices exchange their IDs with the terminal device 205 simultaneously or almost simultaneously, the location of the terminal device 205 may be determined by the triangulation method.

In some embodiments, the server 110 may directly request the terminal device 205 to report its current location at step S440. However, there is not always a response to such a request, for example, because the terminal device 205 has a low battery, a weak signal strength, or no communication capability at all. Further, in some embodiments, the server 110 may request the movable terminal devices 215-1 and 215-3 to report their locations at the time when they were in contact with the missing child 200 at step S445a and S450a, respectively, and they may report the requested locations at step S445 and S450b, respectively, thereby facilitating the server 110 in locating the terminal device 205.

With the embodiment described above, valuable information for finding the missing child 200 may be obtained, such as, who and where the child 200 ever got close to before the missing. With the information, the trajectory of the child may be reproduced, and the witnesses may be identified and tracked. By contrast, such information is no available in the prior art.

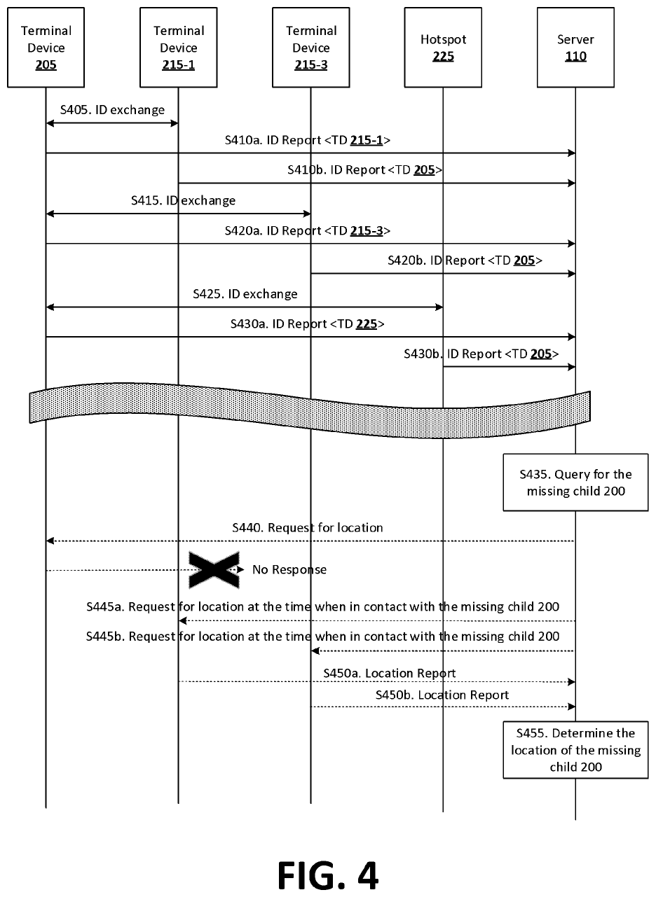

FIG. 5 is a diagram illustrating exemplary scenarios 50 an LBS (e.g., a service for restraining order monitoring) is enhanced by short-range wireless communication according to an embodiment of the present disclosure. As per law, a person who applies a restraining order could forbid a specific person who may hurt him/her to stay away with support by “stay away” provision. Further, a person under criminal detention must follow the strict restriction to stay away from specific locations and/or persons. However, it is very difficult for the polices to positively monitor if the restricted person violates the restriction to get into the restricted places or close to the protected person, because both polices and the restricted person know that there is no such recording. Further, the protected person does not get warning automatically if the specific restricted person follows him/her in short distance. In addition, he/she does not have the evidence to call for police even notice that occasion.

As shown in FIG. 5, a similar floor plan of a shopping mall is provided as that shown in FIG. 2A and FIG. 2B, and therefore a detailed description thereof is omitted for simplicity. As shown in FIG. 5, one or more customers 510-1, 510-2, 510-3 (collectively, the customers 210) and one or more children 507 may be shopping or wandering around in one or more of the stores.

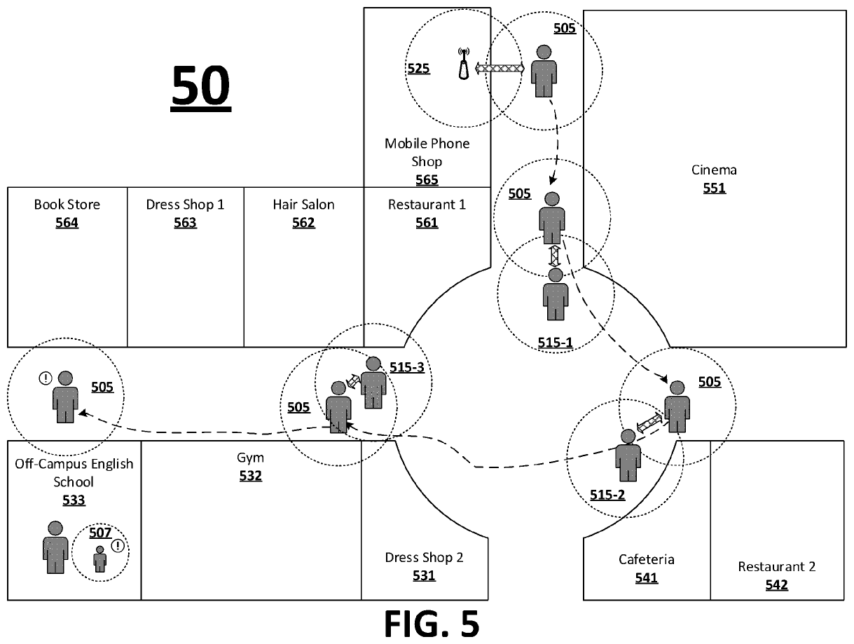

As shown in FIG. 5, a restraining order is issued to a restricted person associated with a terminal device (e.g., an ankle monitoring bracelet) 505, such that he/she is not allowed to be close to a child (and/or its associated terminal device) 507. The terminal device 505 may enter the shopping mall with or without the intention to find the protected child 507. As shown in FIG. 5, the terminal device 505 may exchange the IDs with any other terminal devices that are close thereto. For example, the terminal device 505 may exchange its ID with the hotspot 525 and the terminal devices 215-1 through 215-3. In such a case, the server 110 may receive multiple reports from the terminal devices 505, 525, 515-1, 515-2, and/or 515-3, and record the reports in a table, for example, the table shown in FIG. 6.

Similar to the table shown in FIG. 3, each report may comprise at least an ID of a terminal device that communicated with the reporting terminal device via short-range wireless communication once. For example, the reporting terminal device 505 may report the ID of the hotspot 525 since it was close to the terminal device 525 when the restricted person 505 was entering the shopping mall as shown in FIG. 5.

In some embodiments, a report may further comprise an optional timestamp associated with the ID exchange, such that the server 110 may sort the reports by their timestamps and determine a trajectory of the restricted person 505 as shown in FIG. 5. In some other embodiments, the timestamp may be determined by the server 110 itself. In some embodiments, a report may further comprise an optional location associated with the ID exchange. In some embodiments where a terminal device is associated with a fixed location (e.g., the mobile phone shop 565 shown in FIG. 5), the geographical location of the fixed location may be registered at the server 110 in advance, such that the reporting terminal device may be associated with this geographical location at the server 110 when it reports the ID of the terminal device associated with the fixed location.

Referring back to FIG. 5, when the server 110 detects or otherwise determines that the restricted person 505 is close to the protected child 507, it may issue warnings to at least one of both parties. For example, the server 110 may warn the protected child 507 that the restricted person 505 is coming and the protected child 507 should leave the place where it is now. For another example, the server 110 may warn the restricted person 505 that he/she is about to violate the restraining order and should turn around to leave the place as soon as he/she can. Further, in some other embodiments, the server 110 may warn a third party (e.g., a patrolling policeman nearby) that a restraining order is about to be violated or already violated.

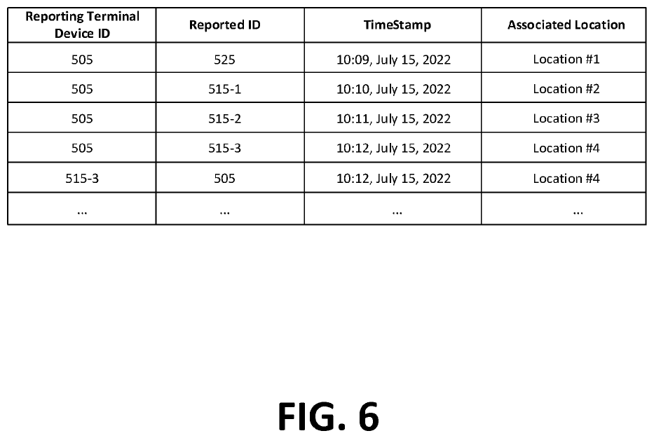

An exemplary procedure for enhancing an LBS (e.g., a service for restraining order monitoring) with short-range wireless communication will be described with reference to FIG. 7A and FIG. 7B together with FIG. 5 and FIG. 6. The procedure may begin with steps S705a and/or S705b, the ID of the protected terminal device 507 may be provided to the terminal device 505 associated to the restricted person, and/or the ID of the restricted terminal device 505 may be provided to the terminal device 507 associated to the protected child. With the IDs, the terminal devices per se may detect whether a restraining order is about to be violated or not without the server 110 involved. However, the present disclosure is not limited thereto. In some other embodiments, the IDs will not be provided, and all the determination of whether a restraining order is about to be violated will be made at the server 110.

At step S710 where the terminal device 505 may detect a signal from the hotspot (or the terminal device) 525 and establish a connection with the hotspot 525 to exchange IDs therebetween. At step S715a and S715b, the terminal devices 505 and 525 may report their received IDs to the server 110. However, the present disclosure is not limited thereto. In some embodiments, the terminal device 505 and/or the terminal device 525 may store the received IDs locally without immediate reporting, and later report all IDs received during a certain period of time altogether to the server 110. Similarly, the terminal device 505 may exchange the IDs of the terminal devices 515-1, 515-2, and 515-3 at steps S720, S730, and S740, respectively, and report the exchanged IDs at steps S725a, S725b, S735a, S735b, S745a, and S745b, respectively. In some embodiments, the reporting of the IDs is not mandatory for a single device. For example, when a terminal device has no access to the server 110 (e.g., the RFID tag 120-4 and the smart phone 120-6 shown in FIG. 1), the other terminal device (e.g., the RFID reader 120-3) may report the close contact between the two terminal devices to the server 110.

Based on the reported IDs, the server 110 may determine, at step S750 that the restricted terminal device 505 is about to violate the restraining order, for example, by the associated locations of the reported terminal devices, by the IDs reported by the restricted terminal device 505 and the protected terminal device 507 having a large number of common IDs within a short period of time. The server 110 may send warnings to at least one of the restricted terminal device 505 and the protected terminal device 507 at steps S755a and S755b, respectively, such that the violation of the restraining order can be prevented to the maximum extent. In some embodiments, an exact location of the restricted terminal device 505 may be provided to the protected terminal device 507, such that the protected child may take a different path than that taken by the restricted person. Additionally or alternatively, the server 110 may send warnings to other parties, such as policeman, an attorney, a judge, or the like, as the evidence that the restraining order is violated.

In general, the solution of some embodiment of the present disclosure takes an advantage of smart phones, smart wearable devices, or dedicated wearable devices, dedicated fix-location devices which equipped the short-range communication module including but not limited to Bluetooth, NFC, or the like. In some embodiments, once there is a device with wireless signal field strength higher than the field strength threshold around the device, it can be considered that these devices are in the state of close contact. Therefore, devices may automatically setup the connection by near-distance communication module, then exchange the device IDs with each other and record them with timestamps.

In some embodiments, at a regular time interval, the devices may automatically upload the records to the server. Each device is uniquely corresponding to the device owner or location. Therefore, the server can restore all owners of such devices, all close contacts, and public venues every day, as well as the specific contact time. All of analysis can be run on the server side. Based on these data, the server could quickly and accurately analyze the close contacts chains which cover all persons or locations equipped the devices.

For the warning function, it could support different warning modes, like warning on both sides of protected and restricted persons, only warning on protected person, only restricted person when close to protected place.

Some embodiments may solve the existing problems as below, the police could proactively monitor the restricted person for whether he/she strictly follows a restraining order. Further, in some embodiments, it could give protected person a sense of safety and deter the restricted person. Besides that, in some embodiments, it could provide great help for the detection of missing child to shorten the time and get right message.

With some embodiments of the present disclosure, the automatic tracking for restricted person to monitor if he/she breaks the restriction order as per the law is enabled. Further, with some embodiments of the present disclosure, valuable information to find out witness and tracking of missing child may be provided. Furthermore, with some embodiments of the present disclosure, the whole system is based on automatic data collection in close contact state among persons and locations by utilizing the devices which include smart phone, smart wearable device, dedicated wearable device or dedicated fixed-location device which is equipped with near distance communication module.

With some embodiments of the present disclosure, the existing problems may be solved or at least alleviated as below, the police could proactively monitor the restricted person for whether he/she strictly follows a restraining order. With some embodiments of the present disclosure, it could give protected person sense of safety and deter the restricted person. With some embodiments of the present disclosure, it could provide great help for the detection of missing child to shorten the time and get right message.

In some embodiments, the IDs (i.e., a device identity) exchanged and reported may be generated by a personal identity with a code of pseudo-random sequence. In some embodiments, the IDs could be permanent or updated regularly which may be synchronized between the terminal devices and server. In some embodiments, a personal identity may be generated by a real personal ID assigned by the government or location. It may be a unique ID in this system which stored in device and server.

In some embodiments, only a device identity is allowed to be exchanged among devices due to privacy consideration. In some embodiments, a timer for blocking exchange may be provided at a terminal device to avoid the repeated exchange with a same device in a short time. After scanning the surrounding devices, a terminal device may check if there are some devices have been just connected shortly before, e.g., based on the timer. If yes, then the connection establishment may be skipped and no ID exchange will be performed. In some embodiments, the timer may be defined by the server and all devices keep the same timer.

In some embodiments, an exemplary work procedure may be provided as follows:
1) Device store Personal Identity which same as which stored in the server.
2) Device Identity is written in device at permanent mode or received from server at regular update mode.
3) Server may send the restricted person's Device Identity to the device of protected person according to setting of warning.
4) Server may send the Device Identity of protected person and forbidden location to the device of restricted person according to setting of warning.
5) After power on, devices may actively scan the surrounding devices with signal strength higher than the threshold.
6) A device may be deleted from a list of devices to be contacted, if the time since the last exchange between the two devices is no longer than the timer for exchange blocking.
7) A list of all available devices may be generated, which may be sorted by their signal strengths.
8) Connections with the devices may be set up according to the device list.
9) After the connection, Device Identity may be exchanged with each other one by one.
10) If the exchanged device is on the list of warning setting, it will trigger the alert on the device and the ID will be uploaded to the server immediately to alert police.
11) If not, the device may regularly report the record of received information to the server.
12) The server could save the close contact recordings as evidence.
13) The server may also determine the track of a missing child to find out the witness and location before its missing.

With some embodiments of the present disclosure, the existing problems may be solved or at least alleviated as below, the police could proactively monitor the restricted person for whether he/she strictly follows a restraining order. With some embodiments of the present disclosure, it could give protected person sense of safety and deter the restricted person. With some embodiments of the present disclosure, it could provide great help for the detection of missing child to shorten the time and get right message.

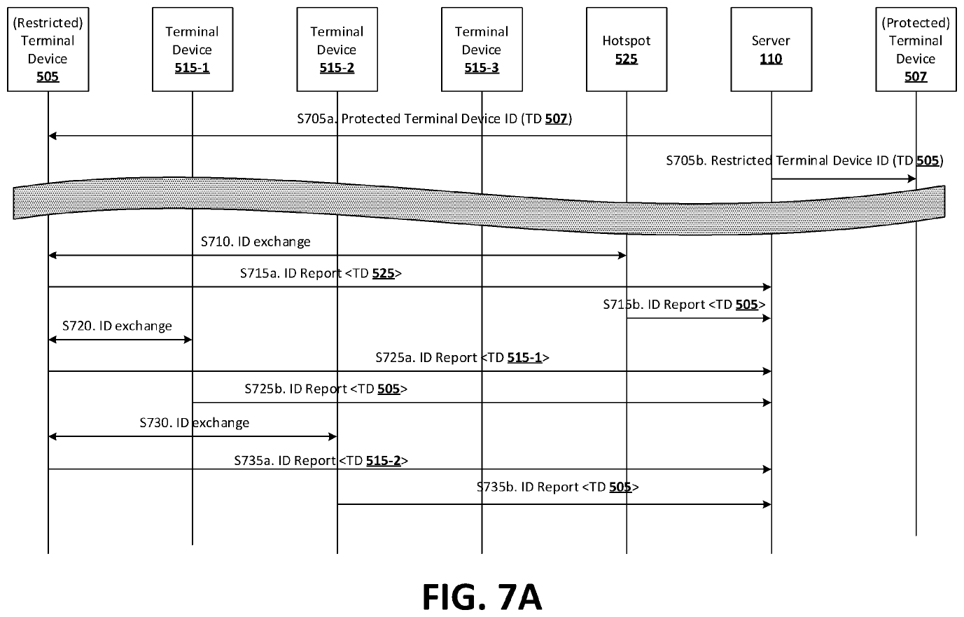

FIG. 8 is a flow chart of an exemplary method 800 at a server for locating a first terminal device according to an embodiment of the present disclosure. The method 800 may be performed at a server. The method 800 may comprise step S810 and step S820. However, the present disclosure is not limited thereto. In some other embodiments, the method 800 may comprise more steps, less steps, different steps or any combination thereof. Further the steps of the method 800 may be performed in a different order than that described herein. Further, in some embodiments, a step in the method 800 may be split into multiple sub-steps and performed by different entities, and/or multiple steps in the method 800 may be combined into a single step.

The method 800 may begin at step S810, where at least one second terminal device may be selected from one or more terminal devices based on at least first information reported by the first terminal device and/or second information reported by the at least one second terminal device, the first information indicating a second identifier of the at least one second terminal device received by the first terminal device via short-range wireless communication, the second information indicating a first identifier of the first terminal device received by the at least one second terminal device via short-range wireless communication.

At step S820, a location of the first terminal device may be determined based on at least a location of the at least one second terminal device.

In some embodiments, before the step of selecting the at least one second terminal device, the method 800 may further comprise at least one of: receiving, from the first terminal device, the first information; receiving, from the at least one second terminal device, the second information; and receiving, from a device other than the first terminal device and/or the at least one second terminal devices, the first information and/or the second information. In some embodiments, the step of selecting the at least one second terminal device may further comprise: selecting the at least one second terminal device further based on at least a specified period of time. In some embodiments, the first information may further indicate that the second identifier of the at least one second terminal device is received by the first terminal device during the specified period of time. In some embodiments, the second information may further indicate that the first identifier of the first terminal device is received by the at least one second terminal device during the specified period of time.

In some embodiments, the step of selecting the at least one second terminal device may comprise: selecting multiple second terminal devices based on at least the first information and/or the second information. In some embodiments, the method 800 may further comprise: sorting locations of the multiple second terminal devices by their corresponding timestamps, each location being associated with a timestamp indicating when the corresponding second terminal device receives the first identifier of the first terminal device and/or the first terminal device receives the second identifier of the corresponding second terminal device; and determining a trajectory of the first terminal device based on at least the sorted locations of the multiple second terminal devices. In some embodiments, the step of determining the location of the first terminal device may comprise: predicting the location of the first terminal device based on at least the determined trajectory of the first terminal device.

In some embodiments, the one or more terminal devices may comprise at least one of: a terminal device that is associated with a fixed location; a terminal device that is able to locate itself by its own positioning module; and a terminal device that is able to locate itself by communicating with another terminal device. In some embodiments, an identifier of a terminal device is a permanent identifier of the terminal device or a temporary identifier that is assigned by a server periodically or in response to a trigger event. In some embodiments, an identifier of a terminal device may be generated based on a pseudo random sequence and a personal identity of a user associated with the terminal device. In some embodiments, the short-range wireless communication may comprise at least one of: Wi-Fi communication; NFC communication; RFID communication; Bluetooth communication; BLE communication; ZigBee communication; Z-Wave communication; IrDA communication; and 3GPP SL communication.

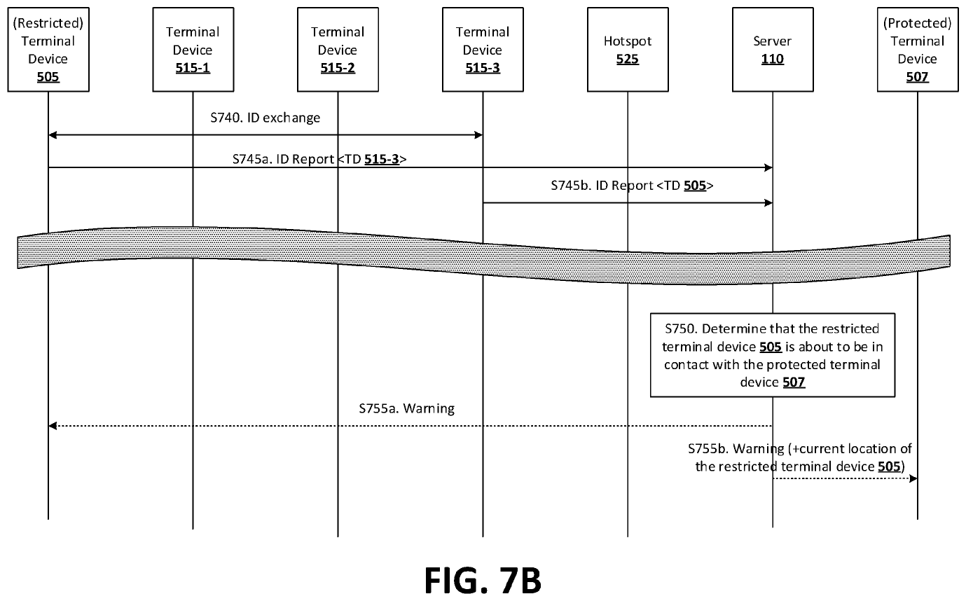

FIG. 9 is a flow chart of an exemplary method 900 at a first terminal device for facilitating a server in locating the first terminal device according to an embodiment of the present disclosure. The method 900 may be performed at a terminal device. The method 900 may comprise step S910, S920, and step S930. However, the present disclosure is not limited thereto. In some other embodiments, the method 900 may comprise more steps, less steps, different steps or any combination thereof. Further the steps of the method 900 may be performed in a different order than that described herein. Further, in some embodiments, a step in the method 900 may be split into multiple sub-steps and performed by different entities, and/or multiple steps in the method 900 may be combined into a single step.

The method 900 may begin at step S910, where whether there is a short-range wireless signal from a second terminal device may be detected.

At step S920, a second identifier of the second terminal device may be received from the second terminal device in response to detecting that there is a short-range wireless signal from the second terminal device.

At step S930, information indicating the second identifier of the second terminal device may be reported to the server.

In some embodiments, the method 900 may further comprise: transmitting, to the second terminal device, a first identifier of the first terminal device in response to detecting that there is a short-range wireless signal from the second terminal device. In some embodiments, before the step of receiving the second identifier of the second terminal device and/or the step of transmitting the first identifier of the first terminal device, the method 900 may further comprise: determining whether the detected short-range wireless signal from the second terminal device has a higher signal strength than a threshold or not, wherein the step of receiving the second identifier of the second terminal device and/or the step of transmitting the first identifier of the first terminal device may be performed further in response to determining that the detected short-range wireless signal from the second terminal device has a higher signal strength than the threshold.

In some embodiments, after the step of transmitting, to the second terminal device, a first identifier of the first terminal device, the method 900 may further comprise: starting a timer for preventing retransmission of the first identifier of the first terminal device to the second terminal device; and preventing the first identifier of the first terminal device from being transmitted to the one second terminal device again until the timer expires. In some embodiments, before the step of receiving the second identifier of the second terminal device and/or the step of transmitting the first identifier of the first terminal device, the method 900 may further comprise: establishing a short-range connection with the second terminal device.

In some embodiments, when multiple short-range wireless signals from multiple second terminal devices are detected, the step of receiving the second identifier of the second terminal device and/or the step of transmitting the first identifier of the first terminal device may be performed for the multiple second terminal devices one by one. In some embodiments, the step of receiving the second identifier of the multiple second terminal devices and/or the step of transmitting the first identifier of the first terminal device may be performed for the multiple second terminal devices one by one in a decreasing order of their signal strengths.

In some embodiments, the information reported to the server may further comprise at least one of: a timestamp indicating when the second identifier of the second terminal device is received by the first terminal device; and a location where the second identifier of the second terminal device is received by the first terminal device. In some embodiments, an identifier of a terminal device may be a permanent identifier of the terminal device or a temporary identifier that is assigned by a server periodically or in response to a trigger event. In some embodiments, an identifier of a terminal device may be generated based on a pseudo random sequence and a personal identity of a user associated with the terminal device. In some embodiments, the short-range wireless signal may comprise at least one of: a Wi-Fi signal; an NFC signal; an RFID signal; a Bluetooth signal; a BLE signal; a ZigBee signal; a Z-Wave signal; an IrDA signal; and a 3GPP SL signal.

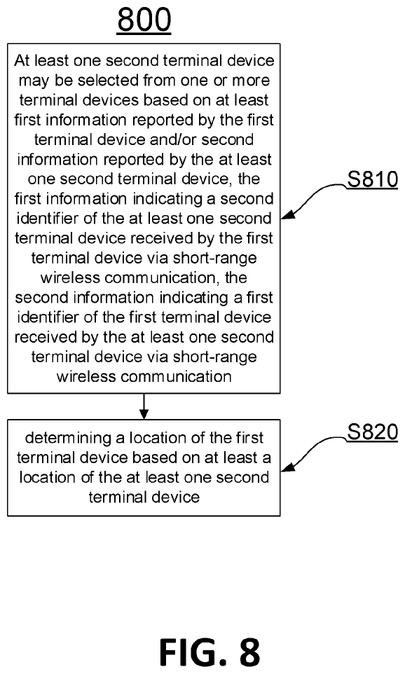

FIG. 10 schematically shows an embodiment of an arrangement 1000 which may be used in a server or a terminal device according to an embodiment of the present disclosure. Comprised in the arrangement 1000 are a processing unit 1006, e.g., with a Digital Signal Processor (DSP) or a Central Processing Unit (CPU). The processing unit 1006 may be a single unit or a plurality of units to perform different actions of procedures described herein. The arrangement 1000 may also comprise an input unit 1002 for receiving signals from other entities, and an output unit 1004 for providing signal(s) to other entities. The input unit 1002 and the output unit 1004 may be arranged as an integrated entity or as separate entities.

Furthermore, the arrangement 1000 may comprise at least one computer program product 1008 in the form of a non-volatile or volatile memory, e.g., an Electrically Erasable Programmable Read-Only Memory (EEPROM), a flash memory and/or a hard drive. The computer program product 1008 comprises a computer program 1010, which comprises code/computer readable instructions, which when executed by the processing unit 1006 in the arrangement 1000 causes the arrangement 1000, the AST, and/or the ASS in which it is comprised to perform the actions, e.g., of the procedure described earlier in conjunction with FIG. 2A through FIG. 9 or any other variant.

The computer program 1010 may be configured as a computer program code structured in computer program modules 1010A and 1010B. Hence, in an exemplifying embodiment when the arrangement 1000 is used in a server, the code in the computer program of the arrangement 1000 includes: a module 1010A configured to select, from one or more terminal devices, at least one second terminal device based on at least first information reported by the first terminal device and/or second information reported by the at least one second terminal device, the first information indicating a second identifier of the at least one second terminal device received by the first terminal device via short-range wireless communication, the second information indicating a first identifier of the first terminal device received by the at least one second terminal device via short-range wireless communication; and a module 1010B configured to determine a location of the first terminal device based on at least a location of the at least one second terminal device.

The computer program 1010 may be configured as a computer program code structured in computer program modules 1010C, 1010D, and 1010E. Hence, in an exemplifying embodiment when the arrangement 1000 is used in a terminal device, the code in the computer program of the arrangement 1000 includes: a module 1010C configured to whether there is a short-range wireless signal from a second terminal device; a module 1010D configured to receive, from the second terminal device, a second identifier of the second terminal device in response to detecting that there is a short-range wireless signal from the second terminal device; and a module 1010E configured to report, to the server, information indicating the second identifier of the second terminal device.

The computer program modules could essentially perform the actions of the flow illustrated in FIG. 2A through FIG. 9, to emulate the server or the terminal device. In other words, when the different computer program modules are executed in the processing unit 1006, they may correspond to different modules in the server or the terminal device.

Although the code means in the embodiments disclosed above in conjunction with FIG. 10 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the server or the terminal device.

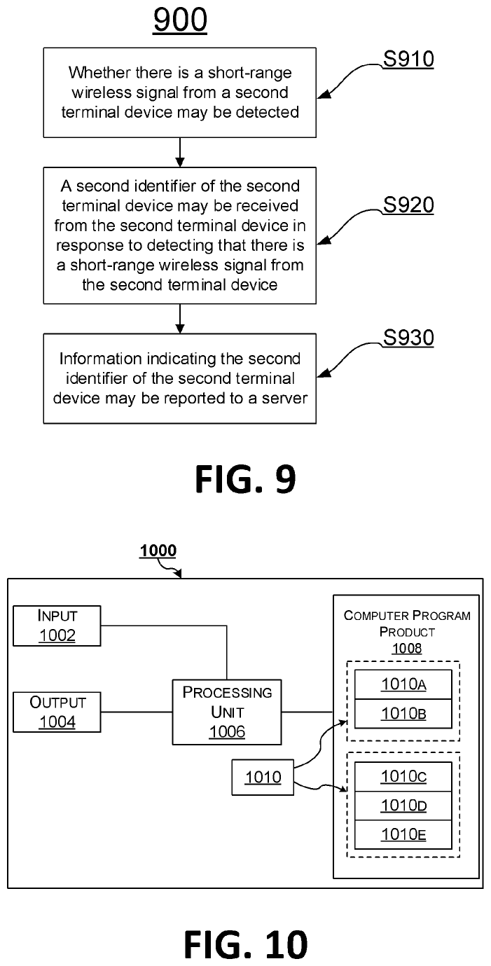

Correspondingly to the method 800 as described above, a server 1100 is provided. FIG. 11 is a block diagram of an exemplary server 1100 according to an embodiment of the present disclosure. The server 1100 can be e.g., the server 110. The server 1100 can be configured to perform the method 800 as described above in connection with FIG. 8. As shown in FIG. 11, the server 1100 may comprise a selecting module 1110 configured to select, from one or more terminal devices, at least one second terminal device based on at least first information reported by the first terminal device and/or second information reported by the at least one second terminal device, the first information indicating a second identifier of the at least one second terminal device received by the first terminal device via short-range wireless communication, the second information indicating a first identifier of the first terminal device received by the at least one second terminal device via short-range wireless communication; and a determining module 1120 configured to determine a location of the first terminal device based on at least a location of the at least one second terminal device.

The above modules 1110 and/or 1120 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 8. Further, the server 1100 may comprise one or more further modules, each of which may perform any of the steps of the method 800 described with reference to FIG. 8.

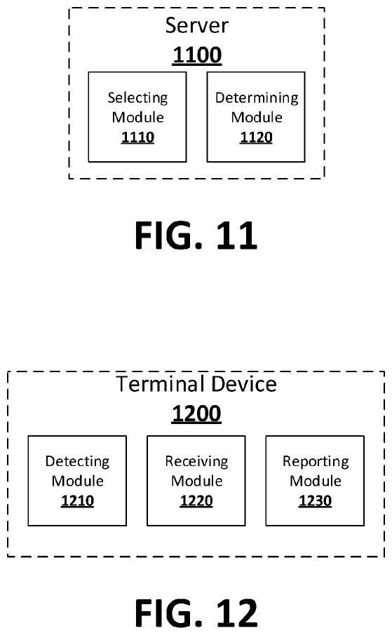

Correspondingly to the method 900 as described above, a terminal device 1200 is provided. FIG. 12 is a block diagram of an exemplary terminal device 1200 according to an embodiment of the present disclosure. The terminal device 1200 can be e.g., the any of the terminal devices 120.

The terminal device 1200 can be configured to perform the method 900 as described above in connection with FIG. 9. As shown in FIG. 12, the terminal device 1200 may comprise a detecting module 1210 configured to whether there is a short-range wireless signal from a second terminal device; a receiving module 1220 configured to receive, from the second terminal device, a second identifier of the second terminal device in response to detecting that there is a short-range wireless signal from the second terminal device; and a reporting module 1230 configured to report, to the server, information indicating the second identifier of the second terminal device.

The above modules 1210, 1220, and/or 1230 can be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 9. Further, the terminal device 1200 may comprise one or more further modules, each of which may perform any of the steps of the method 900 described with reference to FIG. 9.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

What is claimed is:

1. A method at a server for locating a first terminal device, the method comprising:
selecting, from one or more terminal devices, at least one second terminal device based on at least first information reported by the first terminal device and/or second information reported by the at least one second terminal device, the first information indicating a second identifier of the at least one second terminal device received by the first terminal device via short-range wireless communication, the second information indicating a first identifier of the first terminal device received by the at least one second terminal device via short-range wireless communication; and
determining a location of the first terminal device based on at least a location of the at least one second terminal device.

2. The method of claim 1, wherein before the step of selecting the at least one second terminal device, the method further comprises at least one of:
receiving, from the first terminal device, the first information;
receiving, from the at least one second terminal device, the second information; and
receiving, from a device other than the first terminal device and/or the at least one second terminal device, the first information and/or the second information.

3. The method of claim 1, wherein the step of selecting the at least one second terminal device further comprises:
selecting the at least one second terminal device further based on at least a specified period of time.

4. The method of claim 3, wherein
the first information further indicates that the second identifier of the at least one second terminal device is received by the first terminal device during the specified period of time; and/or
the second information further indicates that the first identifier of the first terminal device is received by the at least one second terminal device during the specified period of time.

5. The method of claim 1, wherein the step of selecting the at least one second terminal device comprises:
selecting multiple second terminal devices based on at least the first information and/or the second information.

6. The method of claim 5, further comprising:
sorting locations of the multiple second terminal devices by their corresponding timestamps, each location being associated with a timestamp indicating when the corresponding second terminal device receives the first identifier of the first terminal device and/or the first terminal device receives the second identifier of the corresponding second terminal device; and
determining a trajectory of the first terminal device based on at least the sorted locations of the multiple second terminal devices.

7. The method of claim 6, wherein the step of determining the location of the first terminal device comprises:
predicting the location of the first terminal device based on at least the determined trajectory of the first terminal device.

8. The method of claim 1, wherein the one or more terminal devices comprise at least one of:
a terminal device that is associated with a fixed location;
a terminal device that is able to locate itself by its own positioning module; and
a terminal device that is able to locate itself by communicating with another terminal device.

9. The method of claim 1, wherein an identifier of a terminal device is a permanent identifier of the terminal device or a temporary identifier that is assigned by a server periodically or in response to a trigger event.

10. The method of claim 1, wherein an identifier of a terminal device is generated based on a pseudo random sequence and a personal identity of a user associated with the terminal device.

11. The method of claim 1, wherein the short-range wireless communication comprises at least one of:
Wi-Fi communication;
Near Field Communication (NFC) communication;
Radio Frequency Identification (RFID) communication;
Bluetooth communication;
Bluetooth Low Energy (BLE) communication;
ZigBee communication;
Z-Wave communication;
Infrared Data Association (IrDA) communication; and
3^{rd} Generation Partnership Project (3GPP) Sidelink (SL) communication.

12. A server, comprising:
a processor;
a memory storing instructions which, when executed by the processor, cause the processor to perform operations comprising:
select, from one or more terminal devices, at least one second terminal device based on at least first information reported by the first terminal device and/or second information reported by the at least one second terminal device, the first information indicating a second identifier of the at least one second terminal device received by the first terminal device via short-range wireless communication, the second information indicating a first identifier of the first terminal device received by the at least one second terminal device via short-range wireless communication; and
determine a location of the first terminal device based on at least a location of the at least one second terminal device.

13. A method at a first terminal device for facilitating a server in locating the first terminal device, the method comprising:
detecting whether there is a short-range wireless signal from a second terminal device;
receiving, from the second terminal device, a second identifier of the second terminal device in response to detecting that there is a short-range wireless signal from the second terminal device; and
reporting, to the server, information indicating the second identifier of the second terminal device.

14. The method of claim 13, further comprising:
transmitting, to the second terminal device, a first identifier of the first terminal device in response to detecting that there is a short-range wireless signal from the second terminal device.

15. The method of claim 13 or 14, wherein before the step of receiving the second identifier of the second terminal device, and/or the step of transmitting the first identifier of the first terminal device, the method further comprises:
determining whether the detected short-range wireless signal from the second terminal device has a higher signal strength than a threshold or not,
wherein the step of receiving the second identifier of the second terminal device and/or the step of transmitting the first identifier of the first terminal device are performed further in response to determining that the detected short-range wireless signal from the second terminal device has a higher signal strength than the threshold.

16. The method of claim 13, wherein after the step of transmitting, to the second terminal device, a first identifier of the first terminal device, the method further comprises:
starting a timer for preventing retransmission of the first identifier of the first terminal device to the second terminal device; and
preventing the first identifier of the first terminal device from being transmitted to the one second terminal device again until the timer expires.

17. The method of claim 13, wherein before the step of receiving the second identifier of the second terminal device and/or the step of transmitting the first identifier of the first terminal device, the method further comprises:
establishing a short-range connection with the second terminal device.

18. The method of claim 13, wherein when multiple short-range wireless signals from multiple second terminal devices are detected, the step of receiving the second identifier of the second terminal device and/or the step of transmitting the first identifier of the first terminal device are performed for the multiple second terminal devices one by one.

19. The method of claim 18, wherein the step of the second identifier of the multiple second terminal devices and/or the step of transmitting the first identifier of the first terminal device are performed for the multiple second terminal devices one by one in a decreasing order of their signal strengths.

20. The method of claim 13, wherein the information reported to the server further comprises at least one of:
a timestamp indicating when the second identifier of the second terminal device is received by the first terminal device; and
a location where the second identifier of the second terminal device is received by the first terminal device.

21.-27. (canceled)
